(19) United States
(12) Patent Application Publication
(10) Pub. No.: US 2024/0280430 A1
(43) Pub. Date: Aug. 22, 2024

(54) DEVICES, SYSTEMS AND METHODS FOR DETECTING LEAKS AND MEASURING USAGE

(71) Applicant: IoT Technologies LLC, La Jolla, CA (US)

(72) Inventor: Abraham GREENBOIM, La Jolla, CA (US)

(21) Appl. No.: 18/620,925

(22) Filed: Mar. 28, 2024

Related U.S. Application Data
(63) Continuation-in-part of application No. 17/834,914, filed on Jun. 7, 2022.
(63) Continuation-in-part of application No. 17/834,916, filed on Jun. 7, 2022, now Pat. No. 12,031,687.
(63) Continuation-in-part of application No. 17/834,920, filed on Jun. 7, 2022, now abandoned.
(60) Provisional application No. 63/209,240, filed on Jun. 10, 2021.
(60) Provisional application No. 63/212,568, filed on Jun. 18, 2021.
(60) Provisional application No. 63/212,573, filed on Jun. 18, 2021.
(60) Provisional application No. 63/305,619, filed on Feb. 1, 2022.
(60) Provisional application No. 63/307,370, filed on Feb. 7, 2022.
(60) Provisional application No. 63/322,848, filed on Mar. 23, 2022.
(60) Provisional application No. 63/322,960, filed on Mar. 23, 2022.
(60) Provisional application No. 63/322,897, filed on Mar. 23, 2022.
(60) Provisional application No. 63/209,240, filed on Jun. 10, 2021.
(60) Provisional application No. 63/212,568, filed on Jun. 18, 2021.
(60) Provisional application No. 63/212,573, filed on Jun. 18, 2021.
(60) Provisional application No. 63/305,619, filed on Feb. 1, 2022.
(60) Provisional application No. 63/307,370, filed on Feb. 7, 2022.
(60) Provisional application No. 63/322,848, filed on Mar. 23, 2022.
(60) Provisional application No. 63/322,960, filed on Mar. 23, 2022.
(60) Provisional application No. 63/322,897, filed on Mar. 23, 2022.
(60) Provisional application No. 63/209,240, filed on Jun. 10, 2021.
(60) Provisional application No. 63/212,568, filed on Jun. 18, 2021.
(60) Provisional application No. 63/212,573, filed on Jun. 18, 2021.
(60) Provisional application No. 63/305,619, filed on Feb. 1, 2022.
(60) Provisional application No. 63/307,370, filed on Feb. 7, 2022.
(60) Provisional application No. 63/322,848, filed on Mar. 23, 2022.
(60) Provisional application No. 63/322,960, filed on Mar. 23, 2022.
(60) Provisional application No. 63/322,897, filed on Mar. 23, 2022.
(60) Provisional application No. 63/455,166, filed on Mar. 28, 2023.

(51) Int. Cl. G01M 3/26

(52) U.S. Cl. CPC G01M 3/26

(57) ABSTRACT

A system for leak detection in fluid systems, comprising: a device, comprising: a plurality of sensors, each sensor configured to detect data related to a fluid level in the fluid system, and each sensor device deployed in a different fluid system of the plurality of fluid systems, and at least one hardware processor; and software that is configured to, when executed by the at least one hardware processor, receive data from each of the plurality of sensors, and transmit the fluid data to a platform; the platform comprising: an application coupled with a database, and configured to receive the fluid data and train a model to detect events in the fluid system wherein training the model comprises: validate the fluid data, pre-process the data by dividing the fluid data into two parts with different sample rate, converting the fluid data by taking the absolute value of each part, summing them, and then flattening the fluid data to produce flattened data, normalizing the flattened data to remove offsets, calculating a median and subtracting the median from all data points in the flattened data, concatenated the flattened data for each part to form a single dataset, training a model using the single dataset, and deploying the model to the device.

### CROSS-REFERENCE TO RELATED APPLICATIONS

This application is a continuation-in-part of U.S. patent application Ser. Nos. 17/834,914, 17/834,916, and 17/834,920, each of which was filed Jun. 7, 2002, and all of which claim priority to U.S. Provisional Patent App. No. 63/209,240, filed on Jun. 10, 2021, U.S. Provisional Patent App. No. 63/212,568, filed on Jun. 18, 2021, U.S. Provisional Patent App. No. 63/212,573, filed on Jun. 18, 2021, U.S. Provisional Patent App. No. 63/305,619, filed on Feb. 1, 2022, U.S. Provisional Patent App. No. 63/307,370, filed on Feb. 7, 2022, U.S. Provisional Patent App. No. 63/322,848, filed on Mar. 23, 2022, U.S. Provisional Patent App. No. 63/322,960, filed on Mar. 23, 2022, U.S. Provisional Patent App. No. 63/322,897, filed on Mar. 23, 2022, and also claims priority to U.S. Provisional Patent App. No. 63/455,166, filed on Mar. 28, 2023, entitled “Leak Protection”. These and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### BACKGROUND

### Field of the Invention

The embodiments described herein are generally directed to leak detection and measuring or monitoring usage.

### Description of the Related Art

Often, it can be difficult to detect a leak in a fluid container or conduit such as a swimming pool, toilet, piping, or water/chemical tanks. With respect to liquids, one complicating factor is evaporation. It can be very difficult to determine whether a reduced water level is due to evaporation only, or also due to a leak. Moreover, it can be difficult to detect slow leaks, at least until they have become larger leaks. Imagine a hotel or apartment complex, where there is one main water valve/meter and it is impossible to determine what is happening in each unit or to detect a leak in a specific room or unit, even if the information provided by the main meter indicates that there are one or more leaks. In general dealing with water leakage in houses and residential places is extremely challenging. Finding the source of leaks and resolving them is time consuming and can be difficult. As a result, such work wastes a lot of water before the problem can be identified and repaired. And again, in the case of, e.g., a hotel or apartment building is can be impossible to determine the source of the leak.

### SUMMARY

Accordingly, devices, systems, methods, and non-transitory computer-readable media for fluid leak detection are disclosed herein. Also disclosed herein are devices, systems, methods and non-transitory computer-readable media for monitoring and/or measuring and/or controlling fluid usage, for example, in an appliance, a unit, or a building.

According to one aspect, a system for leak detection in fluid systems, comprising: a device, comprising: a plurality of sensors, each sensor configured to detect data related to a fluid level in the fluid system, and each sensor device deployed in a different fluid system of the plurality of fluid systems, and at least one hardware processor; and software that is configured to, when executed by the at least one hardware processor, receive data from each of the plurality of sensors, and transmit the fluid data to a platform; the platform comprising: an application coupled with a database, and configured to receive the fluid data and train a model to detect events in the fluid system wherein training the model comprises: validate the fluid data, pre-process the data by dividing the fluid data into two parts with different sample rate, converting the fluid data by taking the absolute value of each part, summing them, and then flattening the fluid data to produce flattened data, normalizing the flattened data to remove offsets, calculating a median and subtracting the median from all data points in the flattened data, concatenated the flattened data for each part to form a single dataset, training a model using the single dataset, and deploying the model to the device.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 is a block diagram illustrating an example system architecture on more detail and in accordance with one example embodiment;

FIG. 4 is a diagram illustrating an example hardware design for a device in accordance with one example embodiment;

FIG. 5 illustrates a threshold for use with the device of FIG. 4 in accordance with one example embodiment;

FIG. 6 illustrates the process from data collection to model training to model deployment in accordance with one example embodiment;

FIG. 7 illustrate example data for both an accelerometer and gyroscope included in the device of FIG. 4 for a minor leak;

FIG. 8 illustrate example data for both an accelerometer and gyroscope included in the device of FIG. 4 for a normal flush;

FIG. 9 illustrate example data for both an accelerometer and gyroscope included in the device of FIG. 4 for a medium leak;

FIG. 10 illustrate example data for both an accelerometer and gyroscope included in the device of FIG. 4 for a major leak;

FIGS. 11-17 are screenshots associated with a U/I/dashboard that can be included in the architecture of FIG. 1;

FIG. 18 illustrates the training process for a model that is deployed to the device of FIG. 4 in accordance with on example embodiment;

FIG. 19 illustrates the training process for a model that is deployed to the device of FIG. 4 in accordance with on example embodiment;

FIG. 20 illustrates an architecture for a machine learning model that can be deployed to the device of FIG. 4;

FIG. 21 illustrates an example process for collecting data, pre-processing the data, training a model and deploying the model to the device of FIG. 4 in accordance with on example embodiment;

FIG. 22 illustrates the training and validation loss for a model deployed to the device of FIG. 4 in accordance with one example embodiment;

FIG. 23 illustrates the training and validation loss for a model deployed to the device of FIG. 4 in accordance with one example embodiment;

FIG. 24 is flow chart illustrating a process for inference/monitoring for events in accordance with one example embodiment.

### DETAILED DESCRIPTION

After reading this description, it will become apparent to one skilled in the art how to implement the examples described herein through various alternative embodiments and alternative applications; however, although various embodiments are described herein, it is understood that these embodiments are presented by way of example and illustration only, and not limitation. As such, this detailed description of various embodiments should not be construed to limit the scope or breadth of the present invention as set forth in the appended claims.

In some aspects of the disclosure, systems, methods, and non-transitory computer-readable media are disclosed for measuring usage and/or for leak detection in a container (e.g., pool tank, toilet tank) or conduit (e.g., plumbing pipes) that contains a fluid. Sensors can be placed in or adjacent the container and data can be transmitted to a platform where the data can be viewed and/or transmitted to a user system, e.g., a smartphone application 132 on a user system 130 as described below, for viewing. An example platform 110 on which the systems and methods can be implemented is described first, followed by a description of a processing system 200 on which various aspects of the system can be implemented. The systems and methods are then described in the context of the platform 110 and processing system 200. In some aspects, the platform(s) 110 described herein can execute code using one or more computer processors 210 as described herein.

In some aspects, a system for leak detection is provided, comprising a sensor device comprising at least one sensor configured to detect vertical displacement data (displacement in the z-axis) of liquid in a container, a processing system coupled with the sensor and configured to control the sensor and communicate the displacement data, and a platform 110 comprising a database 114 storing evaluation data, and an application 112 coupled with the database and configured to receive the displacement data and determine if there is a leak in the container (e.g., in the container or associated plumbing) by comparing the displacement data to the evaluation data. In some embodiments, the application 112 is configured to communicate with an automated valve fluidly coupled to the container to cause the valve to adjust (e.g., shut off). In some embodiments, the application is configured to communicate with an external system to schedule (or provide an interface for scheduling) a plumbing consultation or service based on a detection. In some embodiments, the application is configured to communicate with a user system of a service provider, building manager, and/or other entity, to indicate a type of leak, provide evidence, request and receive feedback and/or fluid system information (e.g., confirmation of leak, toilet size or other information, pool size, toilet usage information, age of toilet, pool or other object, date and/or other information relating to a service (e.g., an earlier service) to the fluid system) based at least in part on the displacement data.

In some aspects, the system can further comprise a user system application 132 configured to receive condition information from the platform 110 associated with a status of the container. The user system application 132 can be further configured to display or otherwise transmit an indication of the status of the container via a display of the user system, and/or to receive user feedback, for example, relating to the accuracy of the condition information. The indication can comprise a sound (e.g., an alarm), visual or other indication of a potential leak or abnormal activity. Examples of such applications 132 and user interface/dashboards therefore are described in more detail below.

The sensor device can comprise any suitable sensor(s), including, for example, an accelerometer, a gyroscope, sound sensor, temperature sensor, barometer, ultrasonic sensor, distance sensor, weight sensor, and/or a laser sensor. In some aspects, the sensor is configured to detect displacement in the x-axis, y-axis, and/or z-axis. For example, the x, y and z axis data from an accelerometer and/or gyroscope can be used in determining if there is a leak. In some aspects, the magnitude of a vector (or vector magnitude), for example, according to the equation vector magnitude=√(x²+y²+z², can be used in determining if there is a leak and/or monitoring fluid flow based on the displacement data. It should be appreciated that accelerometer data comes in XYZ coordinate values, and contemplated systems can use accelerometer data in any suitable way in determining movement of the accelerometer (e.g., Delta over time in each coordinate), for example, as the accelerometer floats in the fluid of a container. In some aspects, a formula for the angle of the vector displacement can be used in determining if there is a leak and/or monitoring fluid flow.

The sensor can be place anywhere in the container, including, for example, floating on the surface of the fluid in the container (e.g., toilet tank).

The vertical displacement data can comprise data indicative of a rise and/or drop in the liquid in the container. The vertical displacement data and any other suitable data from the sensor(s) (e.g., fluid data as described elsewhere in this disclosure) can be used to determine whether there is a leak and/or whether a leak is minor, medium, or major.

The evaluation data can comprise any suitable data associated with the system itself, the container, the conduit, the liquid, the gas, and/or containers, conduits and fluids separate of the system, for example, any of the evaluation data described elsewhere in this disclosure. For example, the container can comprise a toilet, a pool, a spa, or a jacuzzi, and the evaluation data can comprise historic displacement data, frequency data (e.g., of flushes or rapid displacements), time data associated with displacement, length of time data associated with displacement, rate data associated with displacement, feedback data (e.g., if a determined leak has been confirmed or reported as inaccurate), threshold data (e.g., when a valve should be adjusted, evaporation data, when a service should be scheduled), vertical displacement data (e.g., different vertical displacement data, historic vertical displacement data, vertical displacement data associated with a different fluid system), movement data, fluid data (e.g., historic fluid data, fluid data associated with a different fluid system), or any other suitable data associated with the toilet, pool, spa or jacuzzi, and/or a different toilet, pool, spa or jacuzzi.

In some aspects, machine learning and/or Artificial Intelligence (AI) is utilized to detect a leak. For example, the system can detect whether data is indicative of normal use conditions or a leak using machine learning and/or Ai algorithms. In some aspects, the system can be trained over time to increase accuracy as to what a normal activity looks like (e.g. a flush has very rapid and extreme vertical displacement in a short amount of time and fills back up) and what an abnormal activity looks like (e.g., a leak with steady downward displacement over a longer period of time). The abnormal activity can comprise, for example, a future leak or a current leak. The algorithms can be trained to determine whether sensor data from a system is indicative of, for example, a normal activity (a normal flush), an abnormal activity (a minor, medium or major leak), a condition, and/or an activity in the fluid system.

The platform 110 can comprise, for example, a user computing device (e.g., a mobile phone, tablet, laptop, computer), or could comprise a third party back end system, which can be coupled to one or more user devices 130.

In some aspects, the systems described herein can further comprise one or more sensors configured to detect at least one of a sound, a temperature, a humidity, an acceleration, and a barometric pressure. The application can be configured to receive sensor data associated with the sound, temperature, humidity, acceleration, barometric pressure, etc. In some aspects, the application can be configured to determine if there is a leak or likely future leak in the container at least in part on the additional data.

According to another aspect, a system for leak detection in a building comprising a plurality of, e.g., toilet tanks is provided, comprising a plurality of sensor devices each configured to detect vertical displacement data of water in a toilet tank, each sensor device of the plurality of sensor devices being deployed in a different toilet tank of the plurality of toilet tanks. The system can further comprise a plurality of processing systems 200, each processing system 200 of the plurality of processing systems 200 coupled with a sensor device of the plurality of sensor devices and configured to communicate the displacement data and/or control the sensor device(s). The system can further comprise a platform 110, comprising a database 114 storing evaluation data, and an application 112 coupled with the database and configured to receive the displacement data and determine if there is a leak in a toilet tank (e.g., the toilet tank or associated plumbing) of the plurality of toilet tanks by comparing the displacement data to the evaluation data. In some aspects, the communication between the main and the devices can be done in mesh networks (e.g., custom made mesh network), for example, in a hotel environment with each device acting as a hot spot to a neighboring device.

In some aspects, the system can further comprise a user system application 132 configured to receive condition information from the platform 110 associated with a status of the one or more of the toilet tanks. The user system application can be further configured to display or otherwise transmit an indication of the status of one or more of the toilet tanks via a display of the user system, and/or to receive user feedback, for example, relating to the accuracy of the condition information. The indication can comprise a sound (e.g., an alarm), visual or other indication of a potential leak or abnormal activity.

The sensor devices can comprise any suitable sensor(s), including, for example, an accelerometer, a gyroscope, sound sensor, temperature sensor, a distance sensor, humidity sensor, barometer, and/or a laser sensor. In some aspects, the sensor is further configured to detect displacement in the x-axis, y-axis, or both. The sensor can be place anywhere in the container, including, for example, floating on the surface of the fluid in the tank, coupled to the float of a toilet tank and/or positioned inside the float. In some aspects, the sensor can be placed outside of the container.

In some aspects, the systems described herein can further comprise one or more sensors configured to detect at least one of a sound, a temperature, a humidity, an acceleration, and a barometric pressure associated with a toilet tank of the plurality of toilet tanks. The application can be configured to receive sensor data associated with the sound, temperature, change in a temperature, humidity, acceleration, barometric pressure, etc. In some aspects, the application can be configured to determine if there is a leak in one or more of the toilet tanks at least in part on the additional data.

In some aspects, the system can further comprise a user system application 132 configured to receive information from the platform 110 associated with a status of at least one toilet tank of the plurality of toilet tanks (e.g., whether there is a leak). In some aspects, the user system application 132 can be further configured to display (or otherwise transmit) an indication of the status of at least one toilet of the plurality of toilet tanks via a display, speaker or other interface of the user system.

In some embodiments, the abnormal condition can comprise a future leak that is determined to be likely based on comparing the fluid data to the evaluation data. For example, by comparing data associated with flush refill over time with, for example, fluid data indicating flush refill time is longer than normal, it can be determined that a leak is starting or imminent, and/or the toilet mechanism is getting old. As another example, the fluid data obtained cam comprise a set of fluid data (e.g., length of time of a flow event and/or output from a dynamo from a flow event, movement data of an accelerometer in the fluid in a container) associated with flow events (or lack thereof) at different times (e.g., at least 2, at least 5, at least 10, at least 15, at least 20, at least 25, at least 50, at least 75, at least 100 different times), for example, within an hour, a 12 hour, a 24 hour, a 48 hour, a 72 hour, or a week period. A pattern and/or a change (e.g., length of time of flow changes by at least 10%, by at least 15%, by at least 20%, by at least 25%, by at least 35%, by at least 45%, by at least 50%, by at least 75%, by at least 100%) can be identified and associated with a condition, such as a future leak. In some aspects, the condition can be determined based on the set of fluid data obtained from the sensor device, evaluation data stored in one or more databases, and optionally other information.

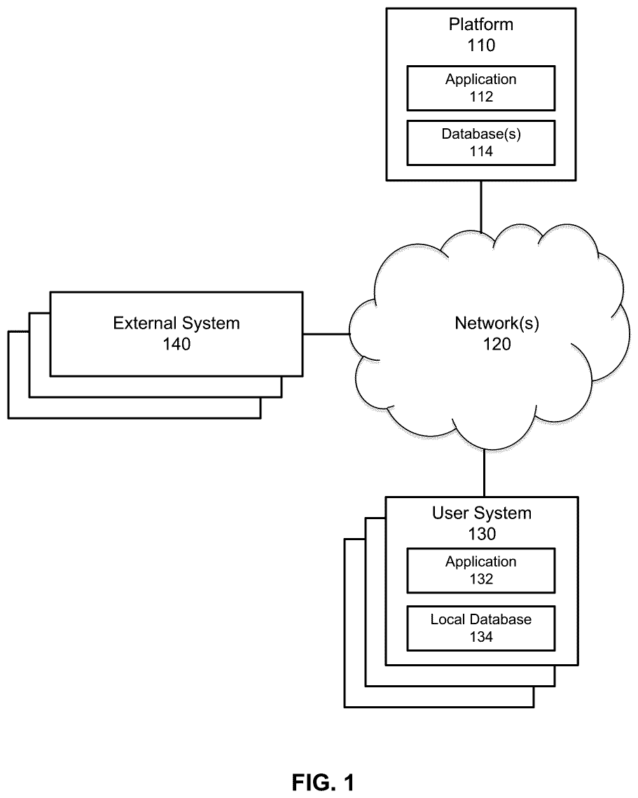

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, 110 may be communicatively connected to one or more user systems 130 via one or more networks 120, or may be entirely implemented on the loopback (e.g., localhost) interface. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases. In addition, communication between any of these systems, for example, platform 110, user systems 130, and/or external system 140, may be entirely implemented on the loopback (e.g., localhost) interface.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134. In some aspects, an application 132 can be downloaded onto a user system 130, such as a user's phone or tablet that allows them to, for example, set up an account and log-on. While user system 130 and platform 110 are shown here as separate devices connected by a network 120. User system 130 may comprise an application 132 that may comprise one portion of a distributed cloud-based system that integrates with platform 110, for example, using a multi-tasking OS (e.g., Linux) and local only (localhost) network addresses.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, or may be entirely implemented on the loopback (e.g., localhost) interface, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST, GET, and PUT request supported by HTTP, via FTP, proprietary protocols, requests using data encryption via SSL (HTTPS requests), and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

While platform 110, user systems 130, and external systems 140 are shown as separate devices communicatively coupled by network 120, each of the devices shown as platform 110, user systems 130, and external systems 140 may be implemented on one or more devices, and/or one or more of platform 110, user systems 130, and external systems 140 may be implemented on a single device.

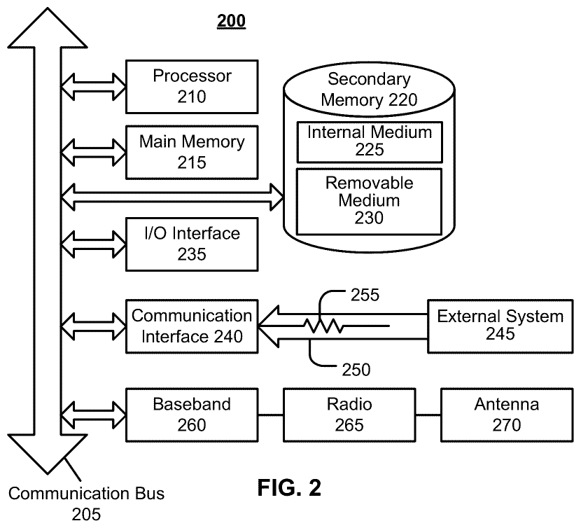

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

Embodiments of processes for leak detection and monitoring and/or measuring water usage will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Thus as noted above, and in accordance with one example embodiment, a system for leak detection is provided, comprising a sensor device comprising at least one sensor configured to detect vertical displacement data (displacement in the z-axis) of liquid in a container (and/or other fluid data such as movement data), a processing system coupled with the sensor and configured to communicate the displacement data (and/or other fluid data), and a platform comprising (and/or coupled to) one or more databases storing evaluation data, and an application coupled with the database and configured to receive the displacement data (and/or other fluid data) and determine if there is a leak in the container (e.g., in the container or associated plumbing) by, for example, comparing the displacement data (and/or other fluid data) to the evaluation data. In some embodiments, the application is configured to communicate with an automated valve fluidly coupled to the container to cause the valve to adjust (e.g., shut off). In some embodiments, the application is configured to communicate with an external system (e.g., of a service company) to, for example, communicate a request for a plumbing consultation or service based on a detection.

In order to detect a leak, one or more sensors can be placed inside a container or tank containing a fluid and float on the liquid, outside and adjacent the container, inside a conduit fluidly coupled to the container, and/or at least partially wrapped around a conduit fluidly coupled to the container. The one or more sensors can be configured to detect, for example, z-displacement, i.e., vertical displacement (e.g., from the one or more sensors to a top of the container or other predetermined location, and/or a lid of the container), and/or any other fluid data as described elsewhere in this disclosure. This vertical displacement (and/or other fluid data) can then be reported to, for example, platform 110. Application 112 can be configured to determine whether the vertical displacement and/or other fluid data is indicative of a leak. In some aspects, determining whether there is a normal or abnormal condition (e.g., leak) associated with the fluid system comprising the container can comprise, for example, determining a vector magnitude, a change in distance from a sensor to a fluid portion (e.g., top of a fluid in a container) over time, a change in distance from a sensor to a predetermined fixed location (e.g., top of a container, a lid of a container) over time, a period of time of a flow associated with the fluid in the container (e.g., passing through a conduit), a movement of the sensor (e.g., accelerometer) over a period of time, or any other suitable data. In some aspects, determining whether there is a normal or abnormal condition (e.g., leak) associated with the fluid system comprising the container can comprise comparing the fluid data to evaluation data as described elsewhere in this disclosure.

Additionally, or alternatively, the displacement data and/or other fluid data and/or data determined by application 112 can be sent to a user system 130 and application 132 can determine whether the displacement data and/or other fluid data is indicative of a leak. For example, the sensor can include or be interfaced with a processing system 200, e.g., via I/O interface 235. Radio 265 can then be used to communicate the displacement data and/or other fluid data to platform 110 and/or user system 130. In certain embodiments, the one or more sensors can be configured to detect displacement along the x, y and/or z axis. For example, the sensor(s) can be a gyroscope, an accelerometer, or both. A gyroscope is a device used for measuring or maintaining orientation and angular velocity.

In some embodiments, the application 112 is configured to communicate with a user system 130 to, for example, communicate a need for a plumbing consultation or service based on a detection, and optionally providing options for service providers and/or information associated with such service providers via a user interface of the user system 130. In some aspects, the application 112 is configured to communicate with an external system 140 and a user system 130 and allow a user and a service provider to schedule a service or visit via inputs and outputs through the external system and user system. In addition, or alternatively, the application 112 is configured to communicate with an external system 140 and/or a user system 130 to communicate condition information and/or provide an alert, which then may lead to external system 140 and user system 130 communicate with one or the other. The indication can comprise a sound (e.g., an alarm), visual or other indication of a potential leak or abnormal activity.

In some embodiments, the application 112 is configured to communicate with a user system 130 of a service provider 140, building manager, and/or other entity, to indicate a type of leak, provide evidence, request and receive feedback (e.g., confirmation of leak) based at least in part on the displacement data (and/or other fluid data). The condition information can include, for example, information corresponding to a normal condition, a small, medium and/or major leak, usage information, a lifetime of a component of the fluid system, or any other suitable information relating to a condition (e.g., status) of a fluid system (which can include the container and plumbing associated therewith). The application 112 can be configured to receive user feedback, for example, relating to the accuracy of the condition information, from the user system and/or external system.

In order for, for example, platform 110 to be able to discern a potentially problematic condition (e.g., a small, medium and/or major leak) from a normal condition (e.g., a flush, evaporation), some information/evaluation data about normal condition should be available. There are several ways such information can be made available.

In some embodiments, evaluation data can be collected as part of an installation process (e.g., the installer can collect baseline evaluation data for stable and normal conditions and the data can be sent to the database(s) 114 via one or more sensor devices and/or via a user system 130 input device. In some aspects, the database(s) 114 can store evaluation data associated with numerous fluid systems located anywhere throughout a home, a building, a city, a county, a state, a country, and/or the world, which can be indicative of various events and conditions.

The evaluation data can comprise any suitable data associated with the system itself, the container, the liquid, and/or containers and liquids outside of the system. For example, the container can comprise a toilet, a pool, a spa, or a jacuzzi, and the evaluation data can comprise historic displacement data under normal and abnormal conditions, frequency data (e.g., of flushes or rapid displacements), time data associated with displacement data, displacement data associated with a condition, length of time data associated with displacement data and/or condition data, rate data associated with displacement data and/or condition data, historic movement data under normal and abnormal conditions, time data associated with movement data, movement data associated with a condition, length of time data associated with movement data and/or condition data, rate data associated with movement data and/or condition data, weight data (e.g., weight data associated with a smaller container in the pool, toilet, spa, jacuzzi or other large container), a change in weight data, feedback data (e.g., if a system determined leak has been confirmed or reported as inaccurate), threshold data (e.g., data values above which a valve should be adjusted, an alert should be provided and/or a service should be scheduled), evaporation data, or any other suitable data. As an example, evaluation data can comprise a length of time associated with a flush refill in a normal state (e.g., 40 seconds average). If sensor data indicates a refill length of time is shorter or longer, this can indicate a leak (e.g., 20-30 seconds indicating a medium leak, and 50 seconds or longer indicating a major leak). Viewed from another perspective, a normal flush refill takes “x” amount of seconds (x being any number) and depends on many technical parameters (e.g., city pressure, house pressure, internal mechanism). By training the system on what flush refill period is set as “normal,” abnormal situations can be detected. For example, a short refill every certain time may indicate a medium leak, while a longer refill more than “x” may mean there is a potential future leak, while a much longer refill time than “x” can indicate a major leak.

In some aspects, the system can be trained over time to increase accuracy as to what a normal activity looks like (e.g. a flush has very rapid and extreme vertical displacement in a short amount of time and fills back up) and what a potentially problematic or abnormal activity looks like (e.g., a leak with steady downward displacement over a longer period of time).

Whether in a toilet tank, pool or another container, it should be appreciated that the sensors can be and/or compose a sensor platform, with sensors configured to detect sound, temperature, humidity, acceleration, barometric pressure, or some combination thereof. The combination of sensors can then be used to determine, motion, vibration, orientation of the sensor platform, to, among other things, provide a sound sample, as well as to sense height of the sensor platform, and/or a change in temperature in the water. For example, an ultrasound or laser system can also be included to detect a distance to the top of the container. These sensors and combinations thereof can be used in addition to, or as an alternative to z-axis displacement to detect a leak. Thus, things like a change in temperature from tank to city water, change of humidity within the tank, tank sound bites, e.g., flushing will run for 4 seconds where leak can be one second or longer periods of time, barometric pressure depicts altitude delta, etc., can be used to detect a leak.

By deploying the systems and methods described herein, sensor devices can be deployed in the toilets and the displacement data and/or other fluid data can be reported to, e.g., platform 110 having an application configured to determine usage and/or condition of a toilet system (or other fluid system of the building) based on sensor data (e.g., fluid data) as described in this disclosure. User systems 130 can then be used to view information associated with the usage and/or condition of one or more toilet systems within the building. Platform 110 can also be configured to alert the user(s) when the data indicates a potential leak. The sensor and platform can actually be used, in such embodiments to provide water usage per toilet, appliance, unit, space and/or owner. This is because the sensor(s) can monitor fluid flowing through various conduits throughout a building (e.g., using vibration data, pressure change data, and any other suitable data), and can measure displacement each time, for example, a toilet is flushed. A flush is something much different than a leak or evaporation and as such, the “signature” for a flush can be detected. But the displacement data and/or other fluid data due to flushing, leaks, evaporation, etc., for each unit can be detected and, for example, displayed and/or provided to a user system of a building manager or other entity. In some aspects, the system can measure usage by getting fluid data and additional data associated with the fluid system (e.g., the size of a toilet tank or pool of a fluid system). A length of time of a flush refill can indicate usage. A small leak might be continuous and prevent a refill of the tank until the leak is fixed. Viewed from another perspective, a normal activity, which can be a flush refill, times the size of the tank, times the number of uses, can indicate a use. A continuous small leak (or a major leak), for example, can prevent the tank from refill and continue water stream until it is fixed. Such a leak can be detected and determined to be indicative of an abnormal event (e.g., a small leak).

Thus, the systems described herein can comprise, e.g., in platform 110, or a user system 130, algorithms and processes that allow the system to recognize a leak based on the patterns, signature, and/or timing of flow, and/or measure usage based on sensor data. Moreover, the system can learn over time to predict leaks, or worsening leaks, as well as inefficient water usage generally.

### Example

This example embodiment deals with detecting leaks in toilet tanks in hotels, apartments, condominium complexes, townhomes, and other dense, or multi-unit commercial or residential complexes, and even single unit houses. The was to create an economical device using cutting edge technologies that could be deployed in such environments. It was determined that IoT devices serve the purpose very efficiently. IoT devices are small, compact and compatible with other enabling technologies. For real-time prediction and analysis Machine Learning models are used. The limitations that had to be overcome include:

| | |
|---|---|
| 1. | Hardware Limitation; |
| 2. | Library Limitation; |
| 3. | Long-tail problem; |
| 4. | Battery Constraint; and |
| 5. | Network Connectivity constraint. |

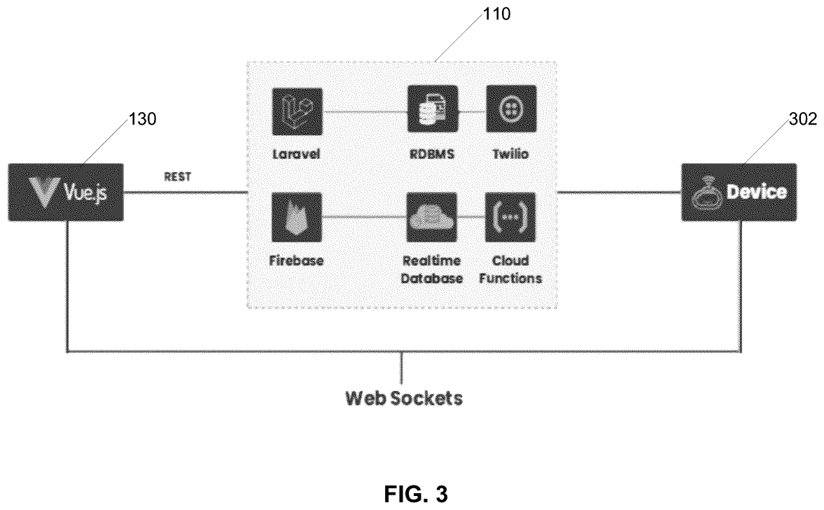

FIG. 3 is a block diagram illustrating an example system architecture on more detail and in accordance with one example embodiment. As can be seen, the architecture can comprise a user system 130 with a frontend user system application 132 that can use a framework, such as the REST framework for API calls to backend platform 110. As can be seen, device 302 with sensors as described above and below can also be interfaced with the front end 130 and/or backend 110 via, e.g., web sockets. To overcome some of the constraints, device 302 can be configured as an edge device. These devices 302 are smart, efficient but compact devices used for water leakage detection. Devices comprise one or more sensors, a CPU, Wi-Fi manager, storage. Sensors sense real-time data from the deployed environment and send data to an ML model for analysis. Devices 302 are configured to smartly manage their sleep cycles as they only awake when a certain threshold is exceeded. A detailed example hardware design for an example device 302 is described in more detail below.

### Frontend:

For the device to function, a dashboard application was needed. Vue.js was used in the development and design of the frontend to create a dashboard application interface for edge devices. As it is best suited for single page apps and user interfaces, Vue.js is a dashboards described below. For backend operations, the frontend can use Laravel and Firebase.

The dashboard application is an interface designed and developed for users to provide access to devices 302, which can be IoT devices. The dashboard can have several features and modules including:
1. Dashboard analytics: All the statistics related to devices, users, alerts and work order are represented in graphical and tabular form, which gives a high-level view to users based on their roles and permissions.
2. Device Module: Devices are handled and managed by users. Users can perform multiple operations related to devices to operate them. One user can have multiple devices and can manage them from his console.
3. User Module: This module is added to manage users by their admins. Admin can add or delete users and assign devices to them.
4. Device Calibration: This feature is added under device module to recalibrate the devices to remove offset values generated by sensors. Device must be calibrated before inference is generated. User can calibrate device anytime though it is previously calibrated at the time of manufacturing.
5. Notification Panel: Notification panel is added to manage notifications. Notifications can be related to leak alerts, workorder status, or reminders such as battery replacement, hardware repairing etc. All notification will be managed under this panel.
6. Work Order: Based on subscription plans and requirements, users have the option of creating work orders to fix the leak. Facilitating prime users by adding this feature.
7. Subscription and Payment module: Providing customers with payment features to handle payments in a more convenient and secure way. Users can avail subscription plans as per their requirements.
8. Data Collection Module: Apart from inference module. Application do have data collection feature in separate. This feature is added to generate more and more diverse data t

### REST Framework:

As noted, the REST framework can be used for API calls between the frontend 130 and backend 110. Every time a request is made from the frontend 130, or a response is received from the device 302, an API is called. To retrieve data and specifics from the backend 110, an API might be used. Best practices for one page web applications are provided via REST, which also enables CRUD functions.

### Backend:

Laravel and Firebase are two key parts of backend 110. The primary controlling body at the backend is Laravel. It maintains and controls all the data, connections, information, role management, and dashboard analytics. Laravel keeps up with backend validations, APIs, and schemas. The second backend entity that is used to deliver real-time database services is Firebase.

Twilio is third-party software used as a service in backend 110 for Workorder feature.

In this example, Maria DB is used as RDBMS for backend to store, retrieve and manage information.

Web sockets are used to connect devices with dashboards. Web sockets are light weight and dedicated sockets used to maintain the connection throughout communication. As compared to http it is way lighter and faster. It induces less latency, fastest connection establishing time, and response time.

Thus, Table 1 is a technical description of the architecture illustrated in FIG. 3.

TABLE 1

| | | |
|---|---|---|
| 1 | Frontend | [symbol] |
| 2 | Backend | [symbol] |
| 3 | Firmware | C++, Arduino, [symbol] , TinyML, https, |
| | | Web Sockets |
| 4 | Machine Learning | [symbol] |
| 4 | [symbol] | [symbol] |
| 5 | Cloud Deployment | [symbol] |

[symbol]

indicates data missing or illegible when filed

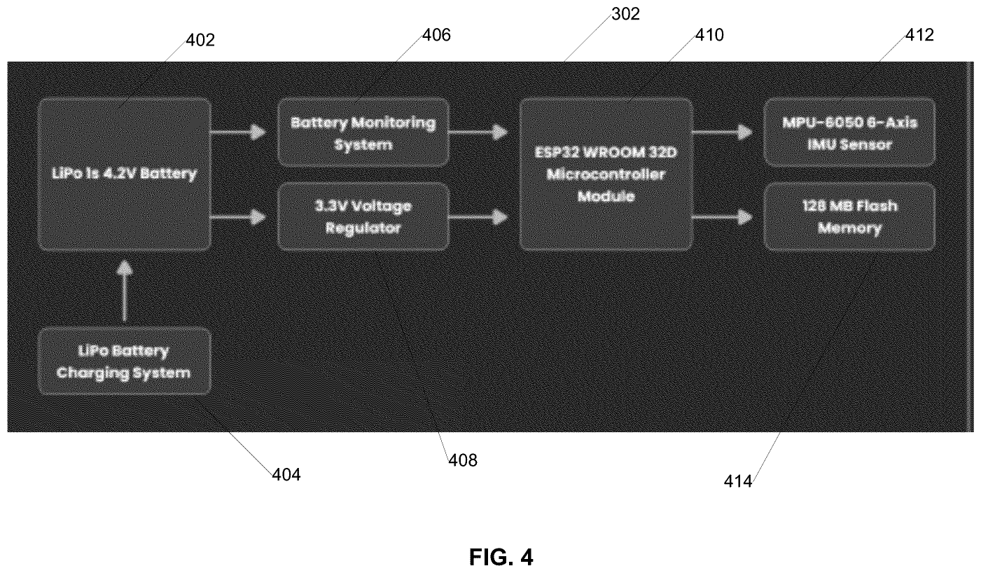

FIG. 4 is a diagram illustrating an example hardware design for a device 302 in accordance with one example embodiment. As can be see, device 302 comprises a battery 402 and battery charging system 404, a battery monitoring system 406, and voltage regulator 408, which is configured to provide one or more operating voltages to a processing module 410, which is in turn interfaced with a sensor module 412 and flash memory 414. False memory 414 would typically store the operating code for processing module 410.

Table 2 is an example specification for processing module 410.

TABLE 2

| | |
|---|---|
| CPUs | Xtensa dual-core 32-bit LX6 microprocessor, |
| | operating at 160 or 240 MHz |
| | Ultra-low power (ULP) co-processor. |
| RAM | 520 KB SRAM out of which 320 KB is DRAM |
| | of which 160 KB is usable [symbol] |
| Connectivity | Wi-Fi: IEEE 802.11 802.11 b/g/n |
| | Bluetooth: v4.2 BR/EDR and BLE |
| GPIO Pins | 34 × programmable GPIO pins |
| ADC (Analog-to- | 12-bit ADC up to 18 channels [symbol] |
| Digital Converter) | |
| Digital Communication | 4 × [symbol] |
| Interfaces | 2 × [symbol] |
| | 2 × [symbol] |
| | 3 × [symbol] |
| Operating Voltage | 3.3 V |

[symbol]

indicates data missing or illegible when filed

Table 3 is an example specification for sensor module 412.

TABLE 3

| | |
|---|---|
| Operating Voltage | 2.3 V-3.4 V |
| [symbol] | 3.9 mA |
| Accelerometer Range | ±2 g, ±4 g, ±8 g, ±16 g |
| [symbol] | ±250/500/1000/2000 [symbol] / [symbol] |
| Communication Interface | [symbol] |
| [symbol] | [symbol] 40° C. to [symbol] 85° C. |

[symbol]

indicates data missing or illegible when filed

Table 4 is an example specification for memory 414.

TABLE 4

| | |
|---|---|
| Operating Voltage | 2.7 V-3.6 V |
| Operating Frequency | [symbol] MHz |
| Memory | 128 MB |
| Operating Temperature | [symbol] 40° C.-85° C. |

[symbol]

indicates data missing or illegible when filed

Table 5 is an example specification for charging system 404.

TABLE 5

| | |
|---|---|
| Input Voltage Range | 0.3 V-9 V |
| Battery Charging Voltage Range | 4.2 V-7 V |
| Max Charge Current | 500 mA |
| Reverse Polarity Protection | Yes |

Table 6 is an example specification for battery 402.

TABLE 6

| Maximum Voltage | 4.2 | V |
|---|---|---|
| [symbol] Voltage | [symbol] .2 | V |
| Number of Cells | 1 | |
| Current Capacity | 500 | mAH |

[symbol]

indicates data missing or illegible when filed

Table 7 is an example specification for voltage regulator 408.

TABLE 7

| | |
|---|---|
| Input Voltage Range | 2.5 V-5.5 V |
| Output Voltage | 1.3 V (Used) |
| Output Current | 500 mA (Max) |

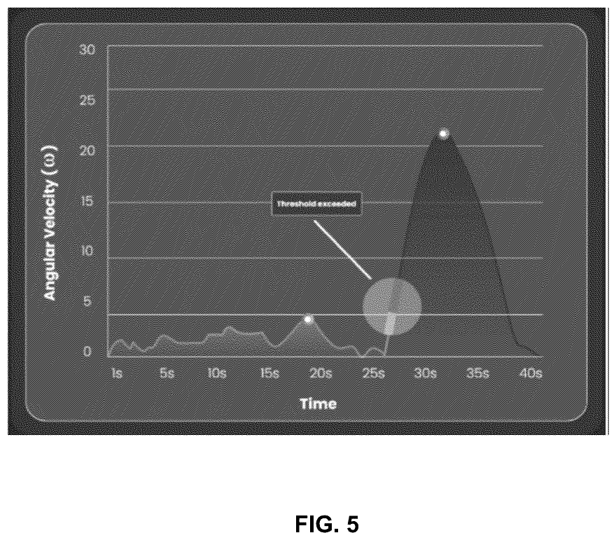

In order to preserve the battery, the device 302 can be configured to operate in sleep mode unless a threshold value is exceeded for, e.g., angular velocity as reported by sensor module 412 as illustrated in FIG. 5.

This section explores statistical properties of data and provides insights about how it is divided into training and validation sets. To build a reliable machine learning model, datasets can be divided into a training set and validation set. Training data is the set of data that is used to train and make the model learn features/patterns in the data. The training data can be fed to the neural network repeatedly, and the model can continue to learn the features of the data. The validation set is a set of data, separate from the training set, that is used to validate the model performance during training. The validation process gives information that helps determine whether the training is moving in the right direction or not. The model is generally trained on the training set, and simultaneously, the model evaluation is performed on the validation set (e.g., after each epoch). The data shows that accelerometer data can be gathered and used for leak detection in accordance with contemplated systems not only in toilets but also in several other applications in other verticals such as agriculture, health and wellness, and various other areas.

The ML model is deployed on device 302 instead of cloud, which minimizes communication and computation cost and make the solution less complex. Avoiding third party cloud services also minimizes the risk of data breeches and increases security. Thus, a small ML model is designed that can be deployed on an IoT device. The ML is comparatively small sized considering the technology constraints. The model is trained using deep learning model. The model is trained only once and deploys on device using, e.g., OTA. The device 302 can then send alerts to the dashboard when leaks are detected based on the trained ML model.

### Machine Learning Model

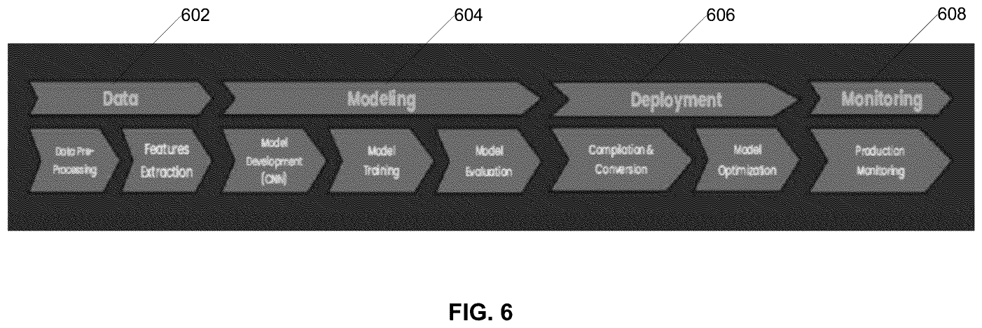

FIG. 6 illustrates the process from data collection to model training to model deployment to the device 302 and then monitoring of events, including the steps of data preparation 602, modeling 604, deployment 606, and monitoring 608. For a toilet detection application, there are often 4 types of events to be monitored: a minor leak, a normal flush, a medium leak and a major leak. Obviously, the types of leaks can be more or less granular than just the three presented in this example.

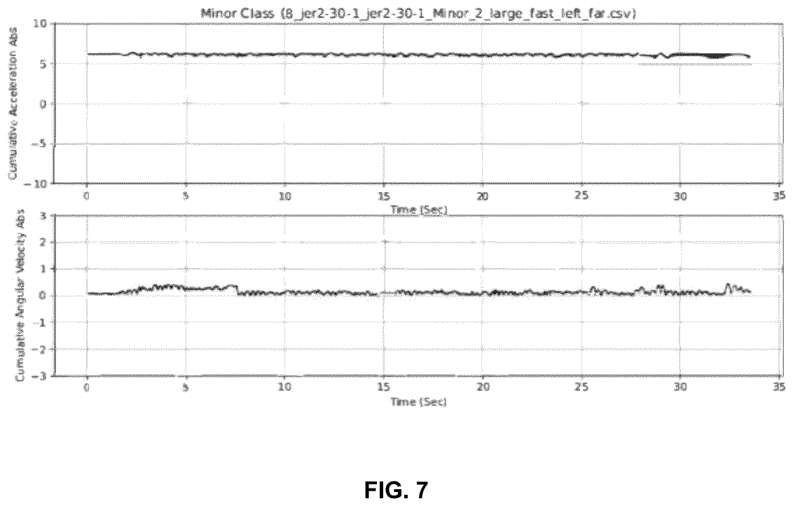

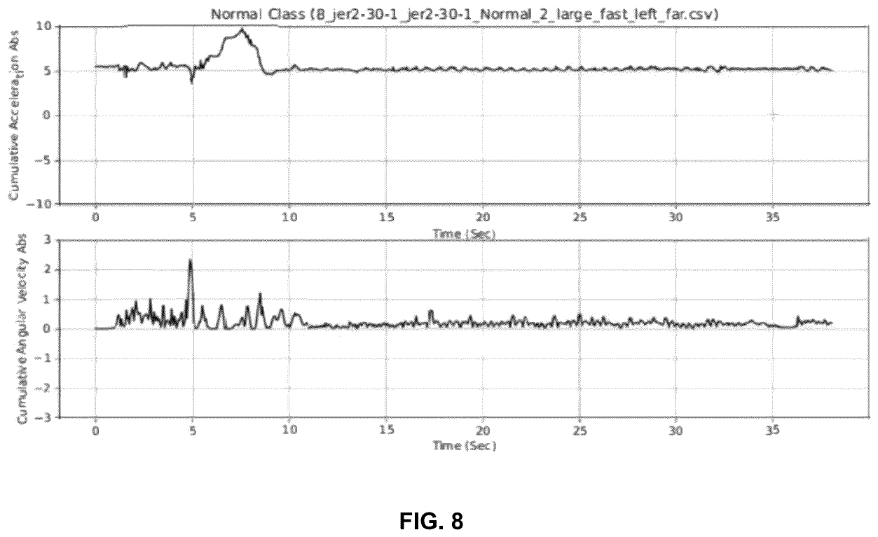

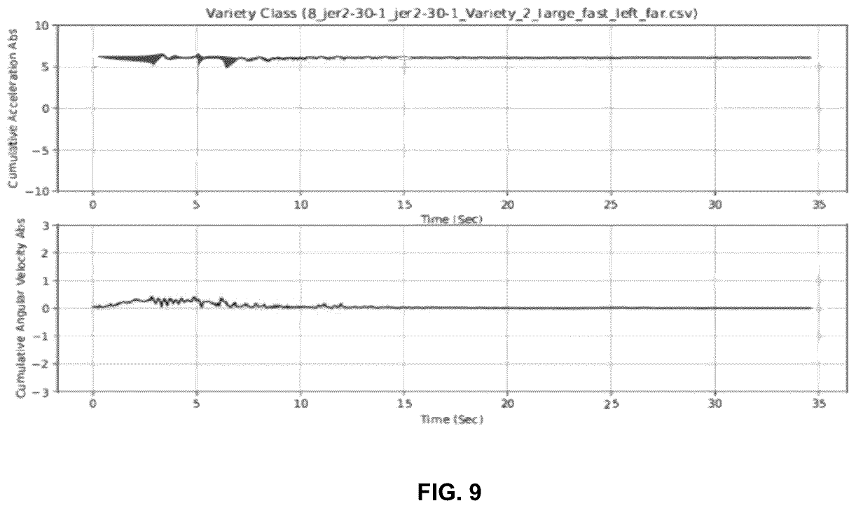

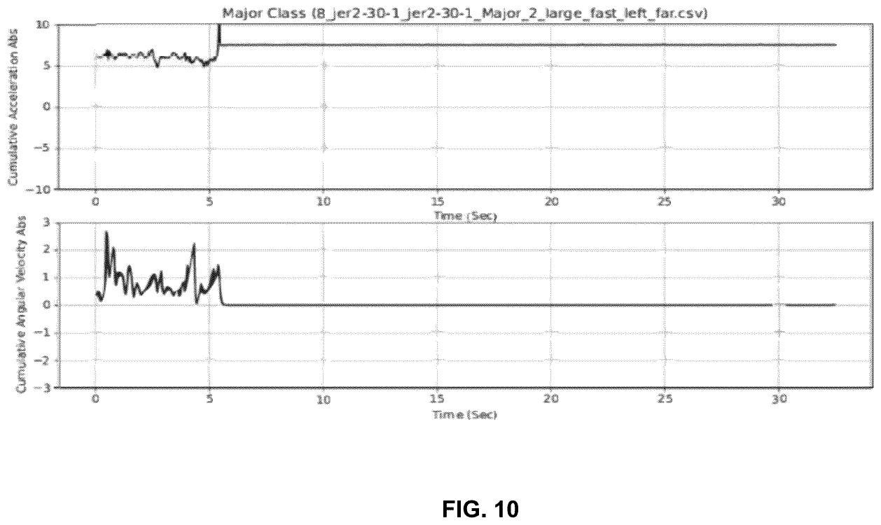

Minor leak is behaviorally basically a very small leak in the flush tank which causes slight movement in the water, but the movement is substantial enough to be picked up by the accelerometer and gyroscope on device 302. Example data for both an accelerometer and gyroscope for a minor leaks is shown in the plots of FIG. 7. The acceleration data is shown in the upper plot and the angular velocity data is shown in the lower plot. The plots in FIG. 8 illustrate the same data for a normal flush, while the plots of FIG. 9 illustrate the data for a medium leak, and FIG. 10 presents example plots for a large leak.

A medium leak is where the water slowly leaks from the tank and is usually so minute it can't easily be capture by the sensors. But after a certain amount of time, the water level will be reduced such that it triggers a refill, which will be captured.

A major leak occurs when the outflow of water is such that the refill volume is not enough to offset the outflow.

The goal then is to model these various events and ensure that the system can differentiate a normal flush, from one of the leak events, and detect the minor and medium leaks with high accuracy. This later objective can be key because the early the system can detect a leak, i.e., before it becomes a major leak can save water and cost obviously.

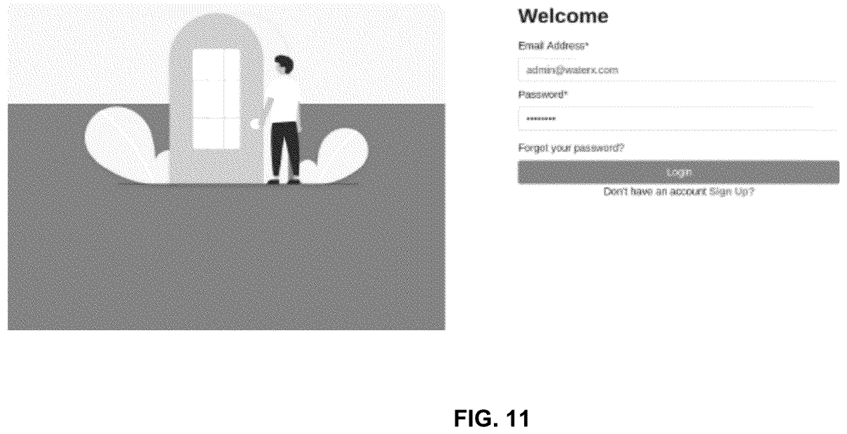

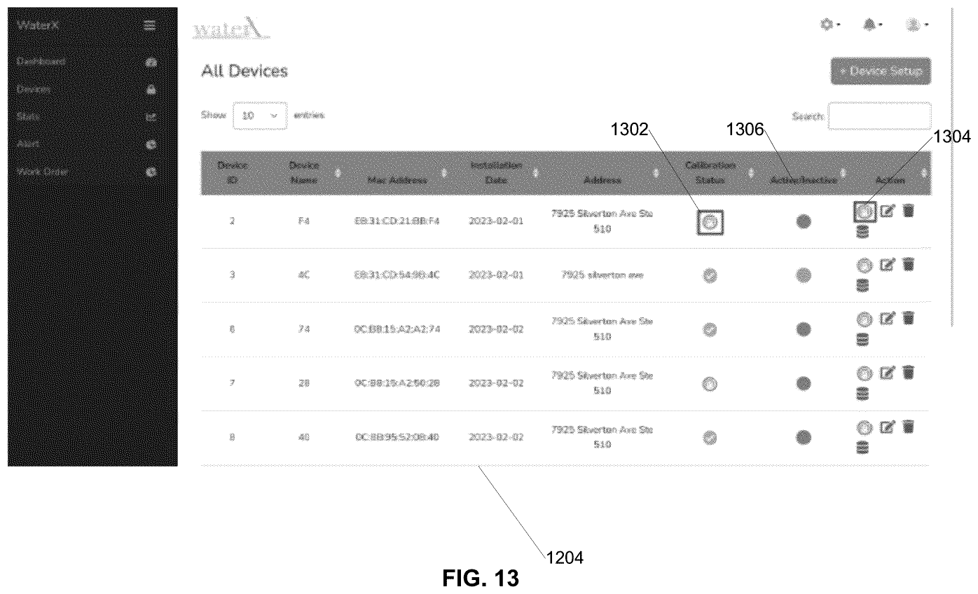

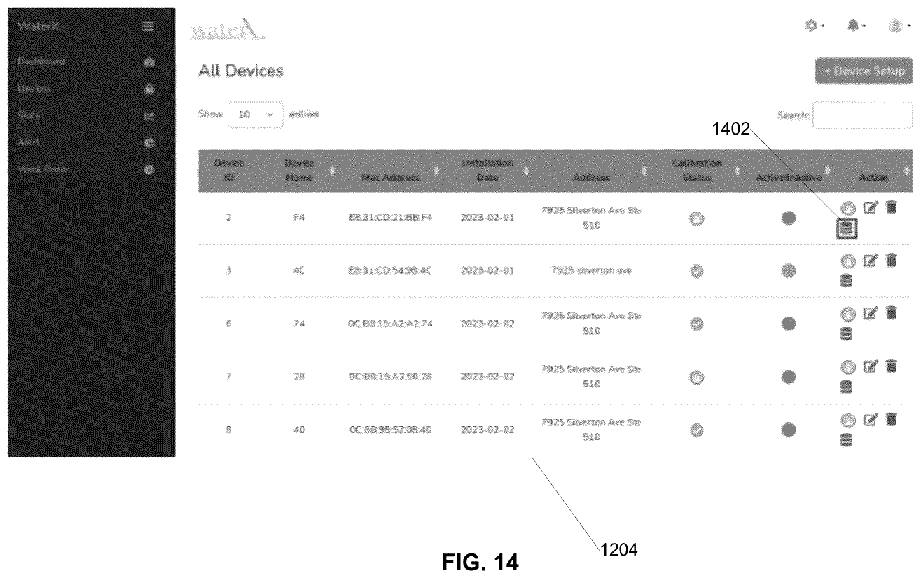

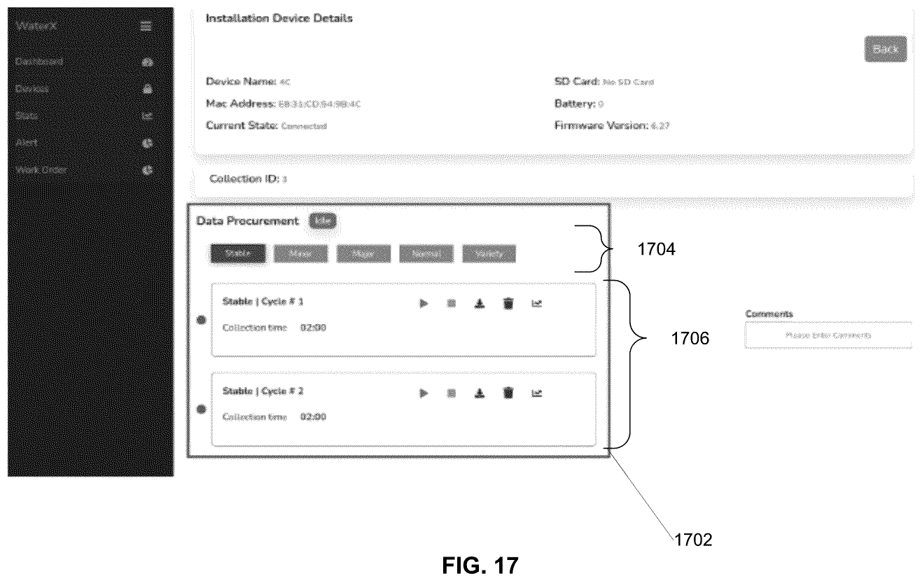

Thus, returning to FIG. 6 the data preparation process 602 can comprise a data collection step. Data collection can be performed using device 302, i.e., via sensor module 412 and can be set up through the U/I/dashboard as illustrated in the screenshots of FIGS. 11-17.

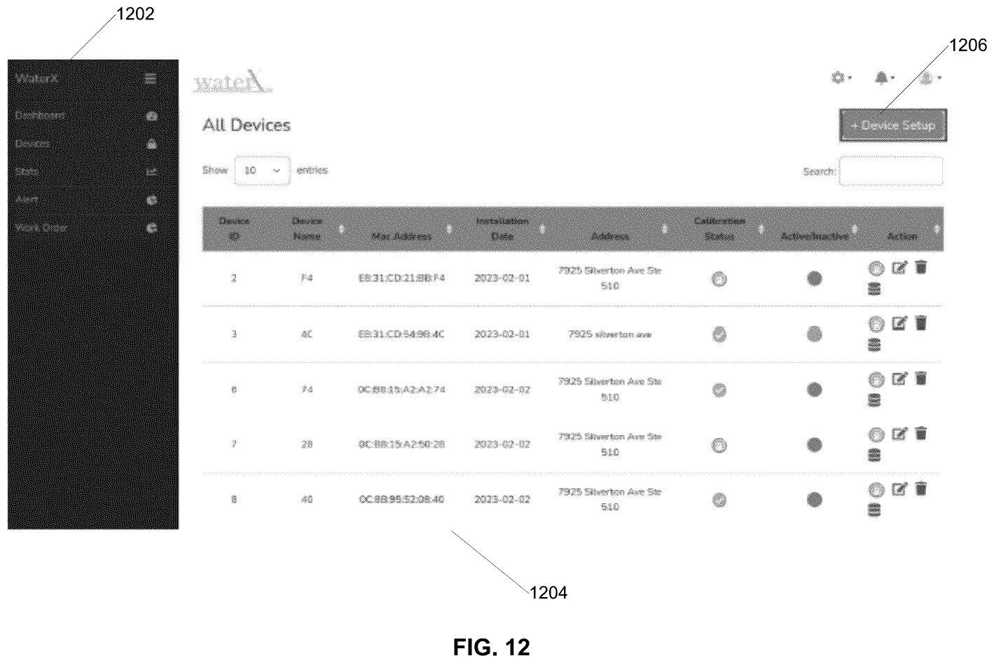

As illustrated in the screen shot of FIG. 11, the user can login to their account on, e.g., platform 110. Once logged in, the U/I can present a menu 1202 that allows the user to select the devices that they have set up as illustrated by the screen shot in FIG. 12. By selecting the device option, area 1204 of the U/I can present all the devices that have been added as well as a device setup option 1206 that allows the user to add new devices.

The device should now be visible in the “All Devices” list in area 1204. The active/inactive status 1306 shows the current connectivity of the devices with the portal. It should be green indicating the device is active. The next step is to calibrate the device, e.g., by clicking on the “Calibrate Device” icon 1304 under the “Action” tab to start calibration. The “Calibration Status” icon 1302 will, e.g., turn green to show the device is calibrated once the calibration is complete.

Once calibrated, the user can select the “Data Collection” icon 1402 under the Action tab to start data collection. In certain implementations, the collection time is variable and data can be collected for any time the user intends; however, the collection time should be determined such that the activity can be fully covered in that specific time. The upper limit for data collection can be 2 minutes or 120 seconds. The sensors can then be sampled at 20 Hz for data collection so for a data sample of 30 seconds we will have 600 values from both the accelerometer and gyroscope. The collected data can be stored as a CSV file in device 302 and then sent to platform 110 to be displayed via the U/I.

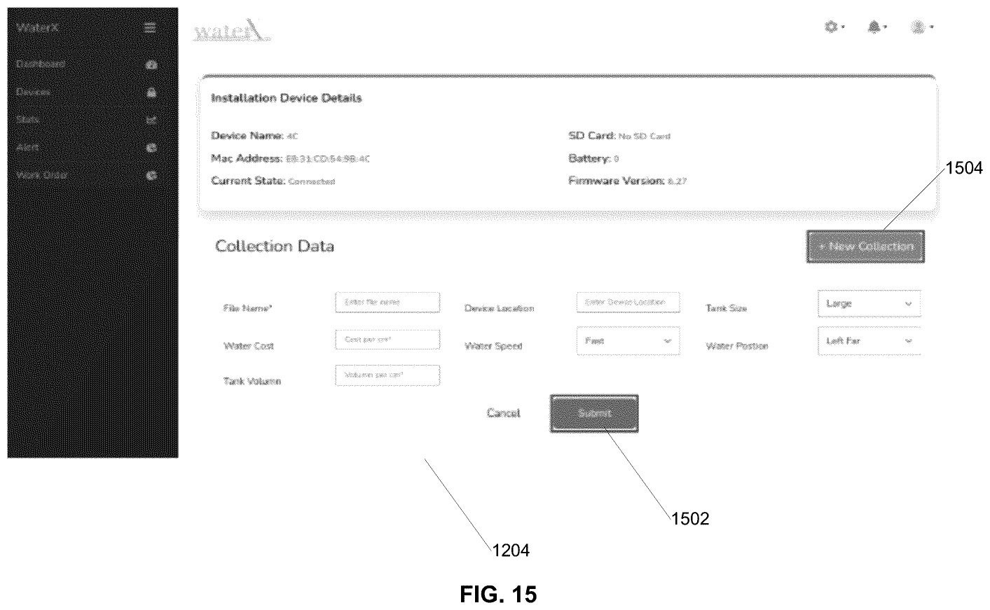

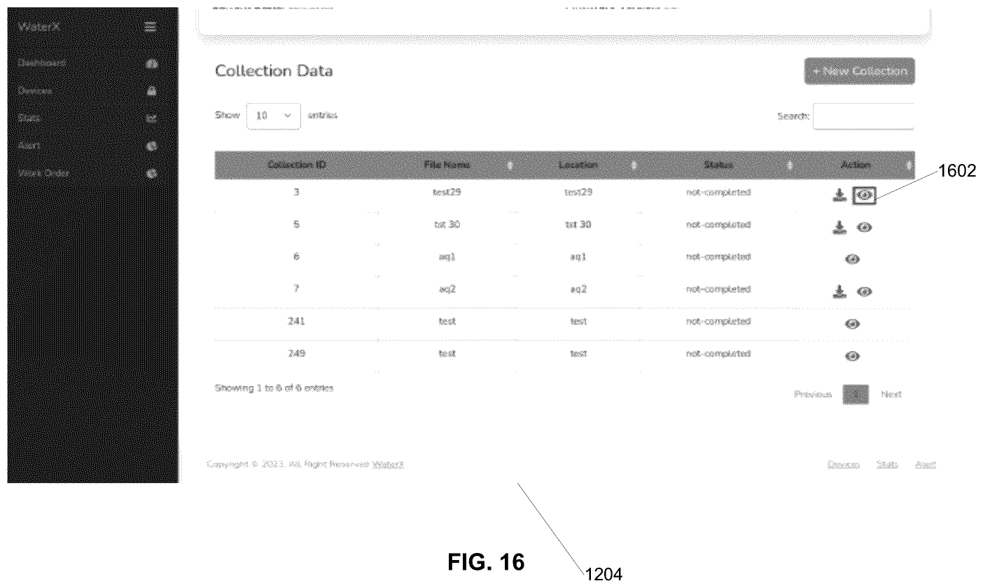

Information related to the data collection can then be presented in area 1205 and should list all the previous collections using the particular device as illustrate din FIG. 16. To download the collected data, the user can, e.g., click on the “New Collection” option 1504, fill in all the respective details, and then select the “Submit” option 1502 when done as illustrated in FIG. 15. The new data collection should now also appear in area 1204 as illustrated in FIG. 16 and can be accessed by selecting the “Data Collection” icon 1602.

A “Data Procurement” section 1702 can be presented in area 1204, that allows the user to click on the respective class label 1704 to collect data of that particular class from “Stable”, “Minor”, “Major”, “Normal” and “Variety”. “Variety” in this example is also known as “Medium”. The user can then use the panels 1706 below to record data for a particular class. The “Start” and “Stop” icons can be used to start and stop data collection respectively. The timer indicates the duration of data collection. For each class, two samples of data can be collected.

Once the data is collected, then data validation can be performed as part of the data step 602. The data is received and several techniques are applied to validate the data. Data validation is further divided into two steps: data format validation and data integrity validation.

During data format validation, the data CSV file is validated to make sure the data is usable for model training. Several checks can be performed including: checking the correct file format (CSV); checking columns of CSV files; checking for null or missing values; checking for correct data-type of values; and checking for lower and upper collection time limits in seconds.

During data integrity validation the data is checked for data integrity by look for any anomaly in the recorded data. This can be done by two methods: compute KL divergence (Kullback-Leibler divergence) between already validated data and new data for each of the four classes (if the new data diverges from validated data by more than a certain threshold, it is discarded); and manual validation and visualization of activity by looking at activity plots.

In one example embodiment, the training set consists of 420 minor, 640 major, and 980 normal examples. Data collection can involve various techniques, such as using a BT app and a dashboard, and had different sample rates throughout the year. Manual analysis revealed 67 mislabeled minor, 33 major, and 24 normal instances, leading to inconsistent model accuracy. After removing these ambiguous examples, our model is now more robust, and predictions are less prone to confusion. After cleaning the data, the model can be trained as described below.

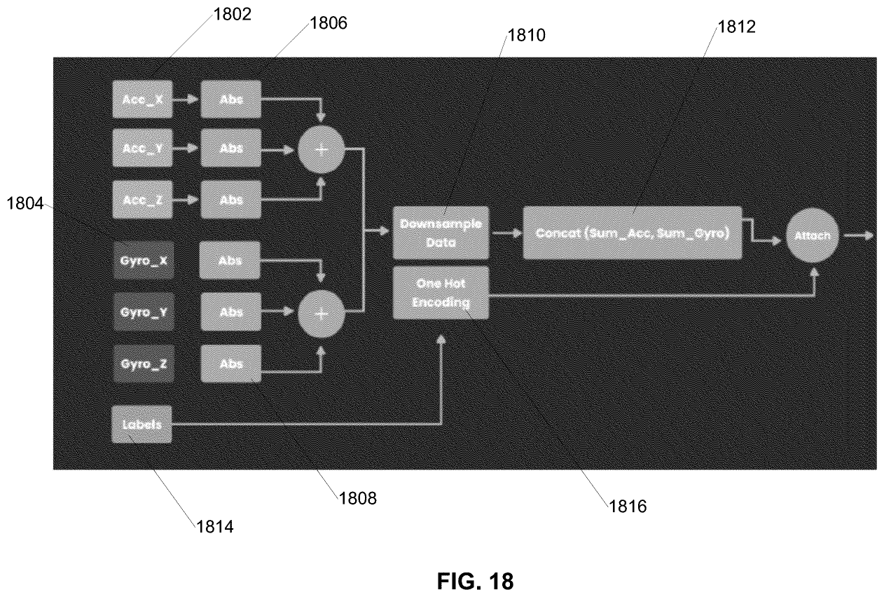

Once the data is collected and validated, the data can be pre-processed in step 2406 so it can then be used to train the model (step 604). Again, this step can be subdivided into two steps: preprocessing for both, e.g., the gyroscope and the accelerometer; and/or for the gyroscope only. FIG. 18 illustrates the training process for both. Here, accelerometer values 1802 for 3 axes (Acc_X, Acc_Y, Acc_Z) and gyroscope values 1804 for 3 axes (Gyro_X, Gyro_Y, Gyro_Z) are recorded for a given window size, which can be 30 seconds for example. The values are fed through absolute to get positive values 1806 and 1808 only and summed for accelerometer and gyroscope respectively. The native sampling rate on the device for both sensors in this example is 20 Hz but can be down sampled to produce down sampled data 1810 to 10 Hz to reduce the window size. Doing this reduces the input values count from 1200 values to 600 values without any major loss in model performance. After the down sampling block, the accelerometer and gyroscope data are concatenated to get an array of size (1×600) 1812. This is then the input to the machine learning model along with labels 1814 for each class, which are encoded using one-hot encoding 1816.

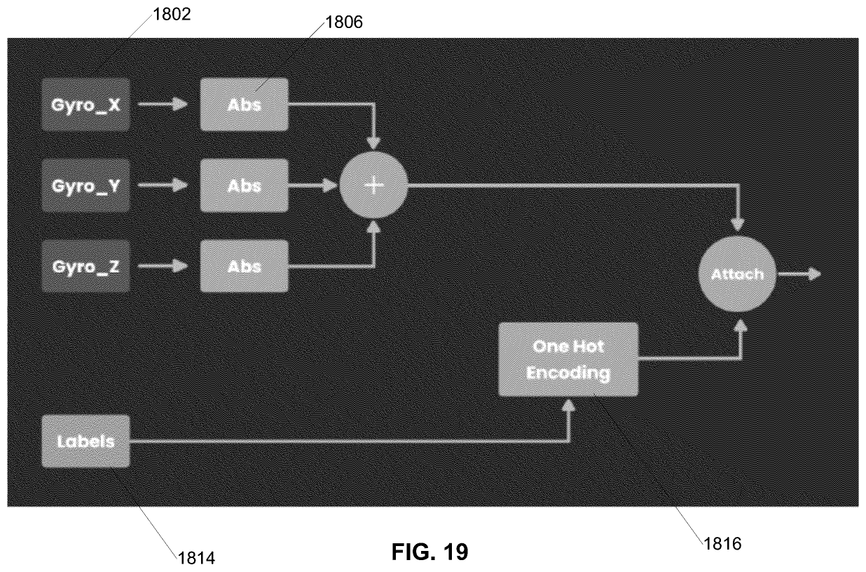

As illustrated in FIG. 19, a simpler approach uses only the gyroscope features. The performance of the model on three classes minor, normal and major is excellent using only the gyroscope features. This indicates that only gyroscope features are sufficient to classify the three classes minor, major and normal. Accelerometer features are however needed when the medium class is included. In this approach the gyroscope values 1802 for 3 axes (Gyro_X, Gyro_Y, Gyro_Z) are recorded for a given window size which is, e.g., 30 seconds. The values are fed through absolute to get positive values 1806 only and summed respectively. This is done in order to just capture the amount of rotational movement of the device 302 as the direction does not provide any important information. The down sampling block is also not included in gyroscope-only features data as more samples can be included in the input window if the accelerometer features are not included. The sampling rate can be 20 Hz and thus for a window size of 30 seconds there will be an input window size of (1×600). The labels 1814 for each class are encoded using one-hot encoding 1816.

In one example embodiment, data collection 2102 involved obtaining 270 points of readings from sensors, capturing 3-axis accelerometer and 3-axis gyroscope data. The data was then divided into two parts with different sample rate: The first 135 values were collected with sample rate of 70 ms and last 135 values with sample rate of 150 ms. So total time of data collection is around 30 seconds. The 270*6 data was then separated into two parts: 270*3 for accelerometer 2104 and 270*3 for gyroscope 2106. In this example, the model requires flattened input, thus the 270*3 data is converted into 270*1 data (2108, 2110) by taking the absolute value of each reading, summing them, and then flattening the data. To normalize the dataset and remove offsets, the median of the 270*1 data is calculated and subtracted from all data points. The same process was applied to the gyroscope data. The result was two chunks of normalized data (270*1 each) which were concatenated (2112) to form a single dataset of size 540*1, with the first half representing accelerometer data and the second half representing gyroscope data.

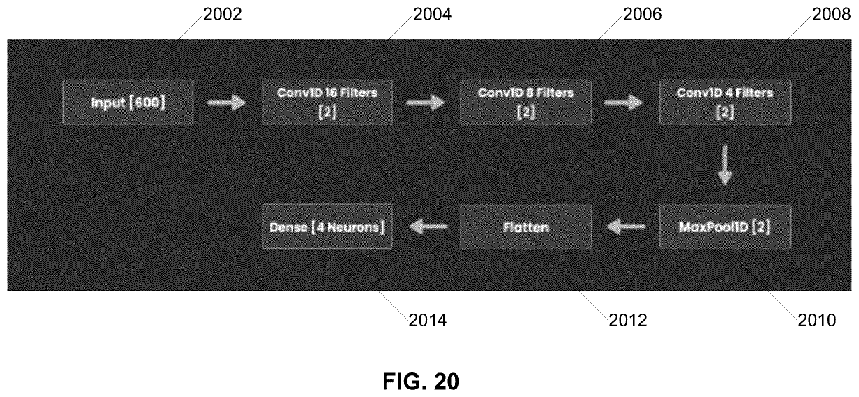

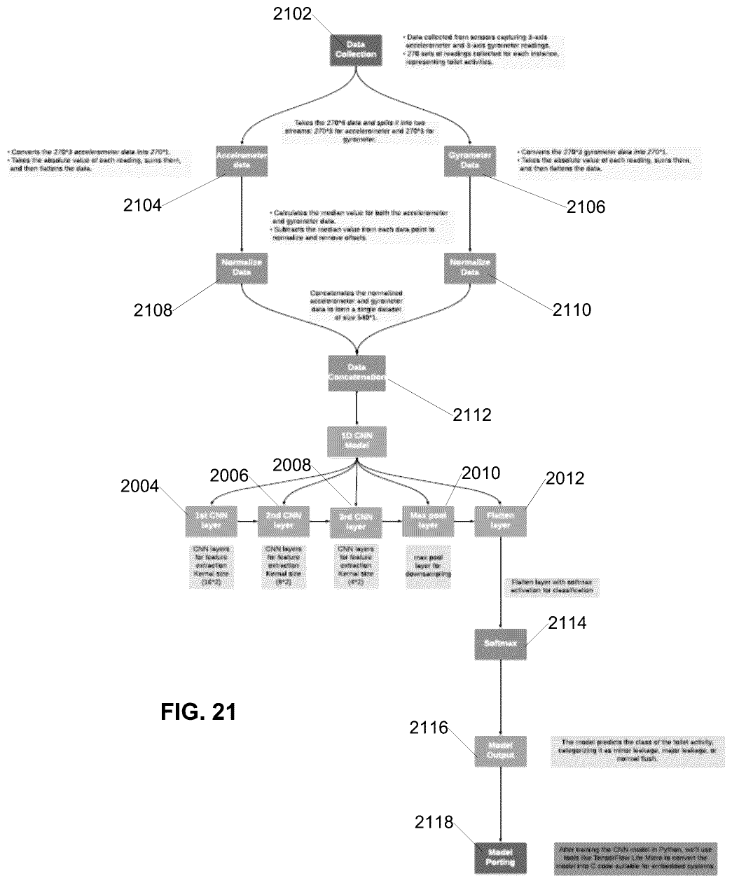

The model can now be trained as per step 604. The machine learning model architecture that is used in can be 1- a dimensional convolutional neural network (1D CNN). The architecture details are illustrated in FIG. 20. The first layer of the model is the input layer 2002 that accepts data in a specific format as described in the previous section. The model contains three 1-dimensional convolutional layers 2004, 2006, and 2008 with decreasing number of filters 16, 8 and 4 respectively, in this example. A 1-dimensional max pooling layer 2010 can be added to reduce the size further and also reduce the number of parameters of the model. Finally, a flatten layer 2012 can be added after which a dense layer 2014 with softmax activation (see FIG. 21) performs the required classification.

Table 8 provides further details about the architecture and the number of parameters of the 1D CNN model.

TABLE 8

| Layer (type) | Output Shape | Param # |
|---|---|---|
| conv1d (Conv1D) | (None, 599, 16) | 48 |
| conv1d_1 (Conv1D) | (None, 598, 8) | 264 |
| conv1d_2 (Conv1D) | (None, 597, 4) | 68 |
| max_pooling1d | (None, 298, 4) | 0 |
| (MaxPooling1D) | | |
| flatten (Flatten) | (None, 1102) | 0 |
| dense (Dense) | (None, 4) | 4772 |

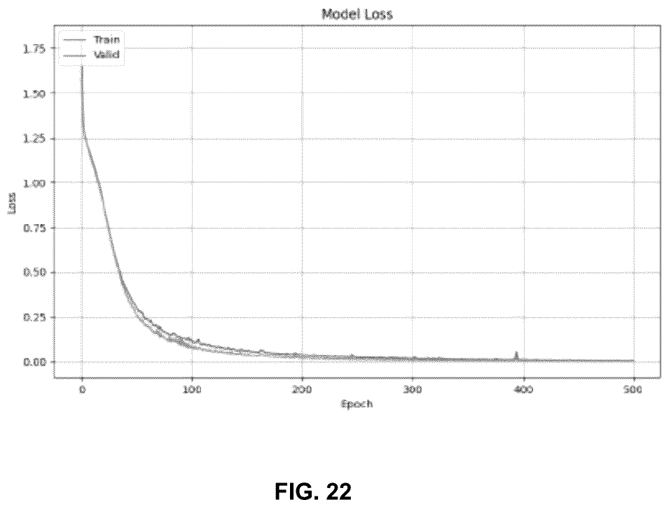

The training and validation loss for the model is given in the plot of FIG. 22.

Training metrics for the model are given in Table 9.

Validation metrics for the model are given in Table 10.

Test Metrics for the model are given in Table 11.

Although the performance of the model is ˜95%+ for the 4-class model, to get 100% performance, two similar classes, minor and medium/variety can be classified under one label in certain embodiments. This would further improve the results of the model. The architecture of this model can be kept the same as the 4-class one.

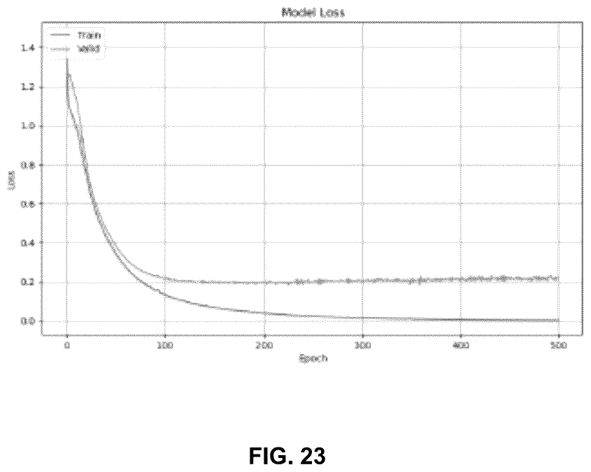

The training and validation loss for the 3-class model is shown in FIG. 23.

Training metrics for the 3-class model are given in Table 12.

Validation metrics for the 3-class model are given in Table 13.

Test Metrics for the 3-class model are given in Table 14.

Now model deployment (606) on the edge device 302 can occur. In certain embodiments, Tinymlgen library is used to port the model from Python to C-code. The EloquentTinyML library is used to deploy the model, e.g., on the ESP32 device 410. Some important features of EloquentTinyML library are: accepts model architecture and weights in a single header file (.h file); provides functions for prediction, post-processing (prediction to label); allows pre-allocation of memory for model parameters and input tensor.

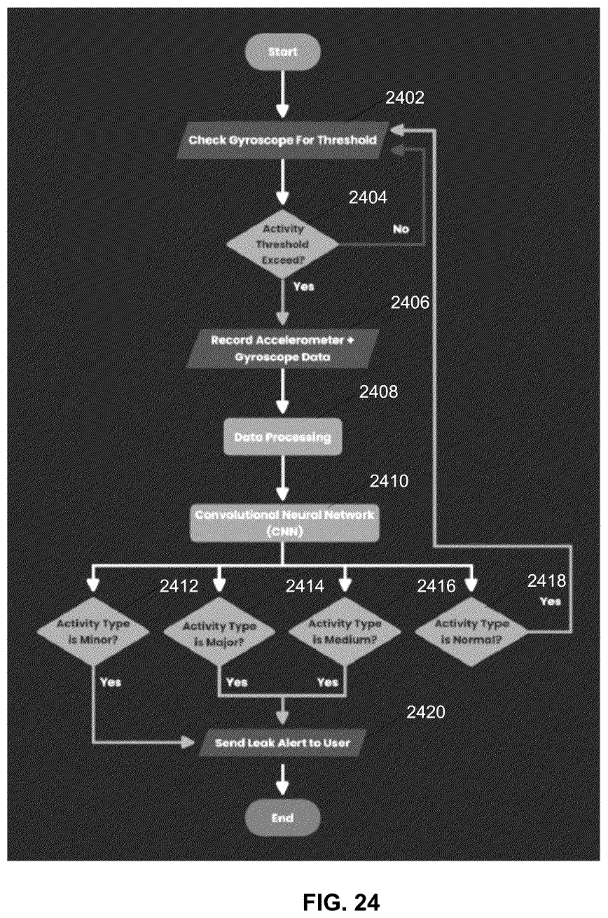

Once deployed, the device 302 can start monitoring step 608. FIG. 24 is flow chart illustrating a process for inference/monitoring for events in accordance with one example embodiment. First, after powering-on the device 302, some initial processes are executed, after which the device goes into sleep mode in which it monitors the gyroscope sensor and only wakes up if gyroscope values exceed a certain threshold in steps 2402 and 2404. The threshold is set on the gyroscope sensor so it is insensitive to gravity and tilt, hence it only indicates movement when there is actual movement of the device. Once an activity starts, in step 2404, the device 302 starts to record accelerometer and gyroscope data for a specified window size in step 2406. The recorded data is then preprocessed in step 2408, as described above, before passing into the model. The preprocessed data is fed into the convolutional neural network (step 2410) to predict the type of activity in steps 2412-2418. After the prediction, if the activity type is normal, the device goes back to sleep mode and threshold check (step 2402 starts again. For minor, major or medium leaks, a notification with the leak type is sent to the user in step 2420.

In certain embodiments, if a leak type is detected, the device powers off after sending the leak notification and must be restarted by the user after addressing the leak.

Thus, specific examples embodiments of devices, systems and methods for leak detection, measuring and/or monitoring usage have been disclosed. Various modifications to these embodiments will be readily apparent to those skilled in the art, and the general principles described herein can be applied to other embodiments without departing from the spirit or scope of the description herein. Thus, it is to be understood that the description and drawings presented herein are therefore representative of the subject matter which is broadly contemplated by the present embodiments. It is further understood that the scope of the present description fully encompasses other embodiments that may become obvious to those skilled in the art and that the scope of the present invention is accordingly not limited.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Reference throughout this specification to “an embodiment” or “an implementation” means that a particular feature, structure, or characteristic described in connection with the embodiment is included in at least one embodiment or implementation, but can also be included in other embodiments described herein or that would be obvious based the present description. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Certain numerical values and ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

All structural and functional equivalents to the components of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for leak detection in fluid systems, comprising:
a device, comprising:
a plurality of sensors, each sensor configured to detect data related to a fluid level in the fluid system, and each sensor device deployed in a different fluid system of the plurality of fluid systems, and
at least one hardware processor; and software that is configured to, when executed by the at least one hardware processor,
receive data from each of the plurality of sensors, and
transmit the fluid data to a platform;
the platform comprising:
an application coupled with a database, and configured to receive the fluid data and train a model to detect events in the fluid system wherein training the model comprises:
validate the fluid data,
pre-process the data by dividing the fluid data into two parts with different sample rate, converting the fluid data by taking the absolute value of each part, summing them, and then flattening the fluid data to produce flattened data, normalizing the flattened data to remove offsets, calculating a median and subtracting the median from all data points in the flattened data, concatenated the flattened data for each part to form a single dataset,
training a model using the single dataset, and
deploying the model to the device.
